(19) United States
(12) Patent Application Publication
(10) Pub. No.: US 2023/0368058 A1
(43) Pub. Date: Nov. 16, 2023

(54) Quantum State Transformation Method, Quantum State Transformation Apparatus and Electronic Device

(71) Applicant: Beijing Baidu Netcom Science Technology Co., Ltd., Beijing (CN)

(72) Inventor: Kun FANG, Beijing (CN)

(21) Appl. No.: 18/316,917

(22) Filed: May 12, 2023

(30) Foreign Application Priority Data
Aug. 3, 2022 (CN) 202210928079.9

(51) Int. Cl. G06N 10/20

(52) U.S. Cl. CPC G06N 10/20

(57) ABSTRACT

A quantum state transformation method, a quantum state transformation apparatus and an electronic device are provided. The quantum state transformation method includes: constructing, based on a target transforming relationship, a first quantum system in a first quantum state, wherein the first quantum state comprises K initial quantum states; constructing, based on the first quantum state and the second quantum state, a second quantum system in an auxiliary quantum state, wherein the second quantum state is obtained by embedding the target quantum state into Hilbert space of the first quantum state based on a preset quantum state; performing, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

### CROSS-REFERENCE TO RELATED APPLICATION

The present disclosure claims priority to Chinese Patent Application No. 202210928079.9 filed in China on Aug. 3, 2022, the entire contents of which are hereby incorporated by reference.

### TECHNICAL FIELD

The present disclosure relates to the technical field of quantum computing, in particular to the technical field of quantum information processing, and in more particular to a quantum state transformation method, a quantum state transformation apparatus and an electronic device.

### BACKGROUND

Quantum state transformation relates to a basic problem in quantum information processing, and is a key step in the practical application of quantum technology. In an application scenario, e.g., the quantum state purification scenario, two or even more noisy initial quantum states can be transformed into a lower-noise target quantum state under allowable operations, and the fidelity between the target quantum state and the ideal quantum state is required to reach a certain threshold.

At present, a multi-copy target quantum state transformation scheme is usually used to realize quantum state transformation, that is, a large number of copies of initial quantum states are transformed into multiple copies of target quantum states in batches.

### SUMMARY

The present disclosure provides a quantum state transformation method, a quantum state transformation apparatus and an electronic device.

According to a first aspect of the present disclosure, a quantum state transformation method is provided, which includes:
constructing, based on a target transforming relationship, a first quantum system in a first quantum state, wherein the first quantum state includes K initial quantum states, and the target transforming relationship is a transforming relationship between N initial quantum states and M target quantum states, the first quantum system includes M first quantum state components, the first quantum state components are superimposed with a uniform probability to obtain the first quantum state, N and M are both integers greater than 1, N is greater than or equal to M, and K is obtained by rounding up a value of N divided by M;
constructing, based on the first quantum state and the second quantum state, a second quantum system in an auxiliary quantum state, wherein the second quantum state is obtained by embedding the target quantum state into Hilbert space of the first quantum state based on a preset quantum state, the second quantum system includes M-1 first quantum sub-systems, the first quantum sub-system includes M second quantum state components, and the second quantum state component is the first quantum state or the second quantum state, the second quantum state components are superimposed with the uniform probability to obtain the auxiliary quantum state;
performing, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

According to a second aspect of the present disclosure, a quantum state transformation apparatus is provided, which includes:
a first construction module, configured to construct, based on a target transforming relationship, a first quantum system in a first quantum state, wherein the first quantum state includes K initial quantum states, and the target transforming relationship is a transforming relationship between N initial quantum states and M target quantum states, the first quantum system includes M first quantum state components, the first quantum state components are superimposed with a uniform probability to obtain the first quantum state, N and M are both integers greater than 1, N is greater than or equal to M, and K is obtained by rounding up a value of N divided by M;
a second construction module, configured to construct, based on the first quantum state and the second quantum state, a second quantum system in an auxiliary quantum state, wherein the second quantum state is obtained by embedding the target quantum state into Hilbert space of the first quantum state based on a preset quantum state, the second quantum system includes M-1 first quantum sub-systems, the first quantum sub-system includes M second quantum state components, and the second quantum state component is the first quantum state or the second quantum state, the second quantum state components are superimposed with the uniform probability to obtain the auxiliary quantum state;
a quantum state transformation module, configured to perform, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

According to a third aspect of the present disclosure, an electronic device is provided, which includes:
at least one processor; and
a memory communicatively connected to the at least one processor; wherein
the memory is configured to store an instruction executable by the at least one processor, and the at least one processor is configured to execute the instruction to implement the quantum state transformation method in the first aspect.

According to a fourth aspect of the present disclosure, a non-transitory computer-readable storage medium storing a computer instruction, wherein the computer instruction is used to be executed by a computer to implement the quantum state transformation method in the first aspect.

According to a fifth aspect of the present disclosure, a computer program product is provided, the computer program product includes a computer program, wherein the computer program is used to be executed by a processor to implement the quantum state transformation method in the first aspect.

According to the embodiments of the present disclosure, it solves the problem on relatively high transformation cost of multi-copy target quantum state transformation scheme, and reduces the overall cost of the quantum state transformation.

It should be understood that the content described in this section is not intended to identify key or important features of the embodiments of the present disclosure, nor to limit the scope of the present disclosure. Other features of the present disclosure will be readily understood through the following description.

### BRIEF DESCRIPTION OF THE DRAWINGS

The drawings are used to better understand the present scheme, and do not constitute a limitation on the present disclosure, wherein:

FIG. 1 is a flowchart of a quantum state transformation method according to a first embodiment of the present disclosure;

FIG. 2 is a first schematic view of a target transforming relationship;

FIG. 3 is an schematic view of transforming a multi-copy target quantum state transformation scheme into a single-copy target quantum state transformation scheme with the assistance of a catalyst quantum state;

FIG. 4 is the second schematic view of the target transforming relationship;

FIG. 5 is an schematic view of a first quantum system;

FIG. 6 is an schematic view of a second quantum system;

FIG. 7 is an schematic view of embedding M target quantum states into a high-dimensional Hilbert space;

FIG. 8 is an schematic view of a first target quantum system;

FIG. 9 is an schematic view of a second target quantum system;

FIG. 10 is an schematic view of a third target quantum system;

FIG. 11 is an schematic view of a fourth target quantum system;

FIG. 12 is an schematic view of a quantum system obtained by discarding a system embedded in the third target quantum system;

FIG. 13 is a flowchart of the quantum state transformation method according to an embodiment of the present disclosure;

FIG. 14 is a schematic structural view of a quantum state transformation apparatus according to a second embodiment of the present disclosure; and

FIG. 15 is a schematic block diagram of an exemplary electronic device used to implement embodiments of the present disclosure.

### DETAILED DESCRIPTION

The exemplary embodiments of the present disclosure are described below in conjunction with the drawings, which include various details of the embodiments in the present disclosure to facilitate understanding, and they should be regarded as exemplary only. Therefore, those ordinarily skilled in the art should recognize that various changes and modifications of the embodiments described herein can be made without departing from the scope and spirit of the present disclosure. Similarly, descriptions of well-known functions and constructions are omitted in the following description for clarity and conciseness.

### First Embodiment

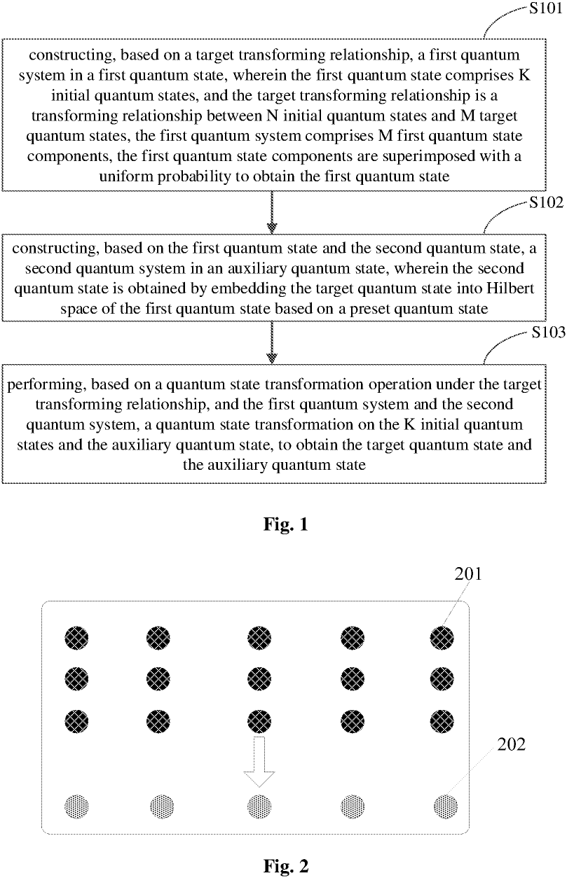

As shown in FIG. 1, the present disclosure provides a quantum state transformation method, which includes the following steps:

Step S101: constructing, based on a target transforming relationship, a first quantum system in a first quantum state, wherein the first quantum state includes K initial quantum states, and the target transforming relationship is a transforming relationship between N initial quantum states and M target quantum states, the first quantum system includes M first quantum state components, the first quantum state components are superimposed with a uniform probability to obtain the first quantum state, N and M are both integers greater than 1, N is greater than or equal to M, and K is obtained by rounding up a value of N divided by M.

In this embodiment, the quantum state transformation method relates to the field of quantum computing technology, in particular to the field of quantum information processing technology, which may be widely applied in the quantum state purification scenario.

For example, in fault-tolerant quantum computing, a special quantum state such as the magic quantum state (magic state) can be subjected to a purification operation to reduce the error of quantum computing results. For another example, in quantum network communication, the entangled quantum state may be purified to enhance the fidelity of information transmission when using entanglement for quantum communication. That is, quantum state transformation, especially quantum state purification operation, is an essential step in realizing fault-tolerant quantum computing and quantum network communication.

According to the embodiments of the present disclosure, the quantum state transformation method may be executed by the quantum state transformation apparatus of the embodiments in the present disclosure. The quantum state transformation apparatus of the embodiments in the present disclosure may be configured in any electronic device to execute the quantum state transformation method of the embodiments in the present disclosure. The electronic device may be a server or a terminal device, which is not specifically limited here.

An ideal quantum state purification scheme is to transform multiple noisy initial quantum states into a low-noise target quantum state, that is, to achieve the transformation of a single-copy target quantum state, while ensuring that the number of initial quantum states used is as small as possible. Due to the constraints on the operations allowed to complete the transformation and the threshold requirement for the fidelity of the transformed quantum state, a single-copy target quantum state transformation scheme does not necessarily exist. That is, in the absence of catalyst quantum state assistance, there is a theoretical limit on the transformation cost of the single-copy target quantum state, and a transformation below this limit may not be implemented.

A multi-copy target quantum state transformation scheme is provided, which may simultaneously transform a large number of copies of initial quantum states into multiple copies of target quantum states in batches, so that the target transforming relationship may be realized, and N copies of initial quantum states are transformed into M copies of target quantum states in batches, that is, the N copies of initial quantum states are consumed to obtain M copies of target quantum states, wherein a copy of quantum state may refer to a quantum state stored in a register, that is, the multi-copy target quantum state transformation scheme needs to consume N initial quantum states stored in a register to obtain M target quantum states.

This transformation method can enable the fidelity of the target quantum state to meet the threshold requirement, and the average number of initial quantum states used to obtain a target quantum state is small, that is, the transformation may be implemented at a low average cost. However, due to the need for a large quantity of transformations, the total number of initial quantum states used is large, which is easy to exceed budget control; in addition, a large number of obtained target quantum states may exceed the number actually needed, resulting in waste. For example, in the magic state purification used in fault-tolerant quantum computing, the average cost may be reduced through large quantity of transformations, but the total cost is huge.

Therefore, in this embodiment of the present disclosure, it provides a quantum state transformation scheme with the assistance of the catalyst quantum state. With the assistance of the catalyst quantum state, i.e., the auxiliary quantum state, any multi-copy target quantum state transformation scheme can be transformed into a single-copy target quantum state transformation scheme with the assistance of the catalyst quantum state, which can greatly reduce the overall cost of quantum state transformation.

For example, it can be applied to the magic quantum state purification in fault-tolerant quantum computing scenarios, the multi-copy magic quantum state purification scheme is transformed into the single-copy magic quantum state purification scheme, which reduces the purification cost and improves calculation accuracy.

For another example, it can be applied to quantum network communication. Since the quantum teleportation is used by the mainstream quantum network architecture to perform the quantum state transmission, it is necessary to perform purification operations on the entangled quantum states involved in the quantum teleportation, so that the transmitted quantum state is not destroyed. The multi-copy entangled quantum state purification scheme is transformed into the single-copy entangled quantum state purification scheme, which can be contributed to reduce the cost of entangled quantum state purification, improve the precision of entanglement transformation, and thus further improve the fidelity of quantum state transmission.

It is assumed that the target transforming relationship is established, the target transforming relationship can be realized by a multi-copy target quantum state transformation scheme F, which transforms N copies of initial quantum states ρ into M (M≤N) copies of ideal quantum states, the fidelity between the target quantum state η^{M} obtained by transforming and the ideal quantum state σ^{⊗M} is 1-∈ (0≤∈≤ 1), and the transformation success probability is p. As a result, in this embodiment, it may improve a single-copy target quantum state transformation scheme F′ with the assistance of a catalyst quantum state, so that K=[N/M] (that is, K is not less than the smallest positive integer of N divided by M) copies of initial quantum state ρ can be transformed into one copy of target quantum state, and the fidelity between the target quantum state obtained by transforming and the ideal quantum state is 1-∈, and the success probability is p.

FIG. 2 is an schematic view of the target transforming relationship, a perfect transformation situation (i.e. ∈=0, indicating that the target quantum state obtained by transforming is the same as the ideal quantum state, and p=100%, which indicates that each target quantum state is transformed successfully) is drawn in FIG. 2, the specific implementation is not limited herein. It is assumed that there is a multi-copy target quantum state transformation scheme F to transform N=15 copies of initial quantum states ρ (indicated by dot 201) into M=5 copies of target quantum states σ (indicated by dot 202), that is, the target quantum states obtained in FIG. 2 correspond to the ideal situation of the perfect transformation, that is, 5 copies of the target quantum states, represented by σ^{⊗5}. In practice situations, it is possible to allow correlations between the target quantum states (that is, dots that are not independently distributed).

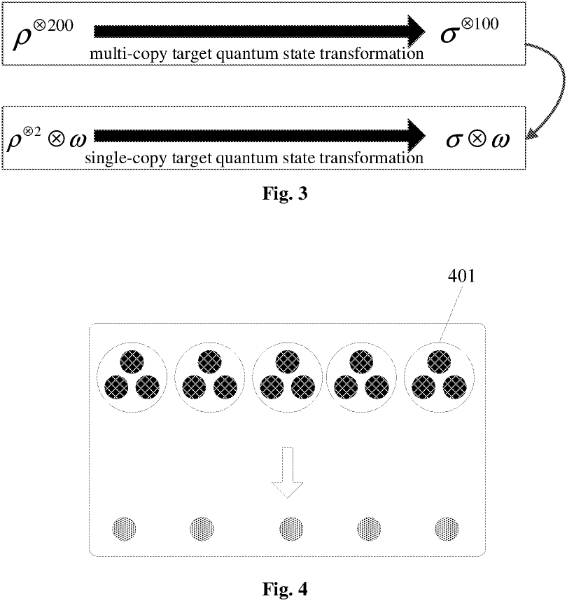

For example, as shown in FIG. 3, there is a multi-copy target quantum state transformation scheme, that is, transforming 200 copies of initial quantum states into 100 copies of target quantum states. In this embodiment of the present disclosure, it can transform the multi-copy target quantum state transformation scheme into the single-copy target quantum state transformation scheme with the assistance of the catalyst quantum state. Specifically, with the assistance of the catalyst quantum state, 2 copies of initial quantum states and the catalyst quantum state may be used to implement the quantum state transformation, that is, one copy of target quantum state may be obtained.

In the specific implementation, in a case that the target transforming relationship is established, it determines that the number of initial quantum states used to obtain a target quantum state on average is K, K is obtained by rounding up based on the value of N divided by M, that is, K=[N /M], and K copies of quantum states ρ are formed as a group, recorded as ζ = p^{⊗K}, ζ is the first quantum state. Correspondingly, the target transforming relationship shown in FIG. 2 may be expressed as shown in FIG. 4, wherein the circle 401 represents the first quantum state, and the target transforming relationship may include M groups of the first quantum states ζ, represented by ζ^{⊗M}.

Then, a first quantum system in the first quantum state may be constructed, and the first quantum system may include M first quantum state components, and the M first quantum state components may be superimposed with the uniform probability to obtain the first quantum state.

In an optional embodiment, the first quantum state may be divided into M components, each of the components is 1/M of the first quantum state, and the first quantum state may be obtained by superimposing the M components, and the first quantum system may be obtained by constructing based on the M components.

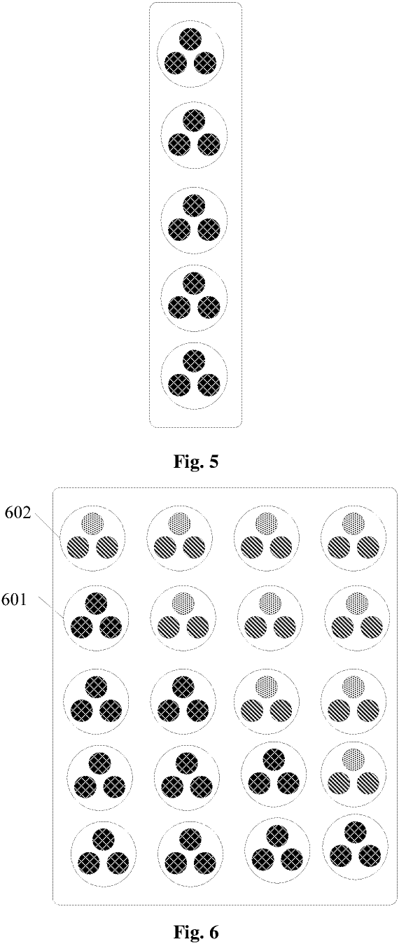

In another optional embodiment, the first quantum state can be used as a component, and the first quantum state can be obtained by superimposing M components with a uniform probability of 1/M, and the first quantum system can be constructed based on these M components. As shown in FIG. 5, this column represents the first quantum system, and each row of this column represents a first quantum state component.

Step S102: constructing, based on the first quantum state and the second quantum state, a second quantum system in an auxiliary quantum state, wherein the second quantum state is obtained by embedding the target quantum state into Hilbert space of the first quantum state based on a preset quantum state, the second quantum system includes M-1 first quantum sub-systems, the first quantum sub-system includes M second quantum state components, and the second quantum state component is the first quantum state or the second quantum state, the second quantum state components are superimposed with the uniform probability to obtain the auxiliary quantum state.

In this step, the second quantum state is obtained by embedding the target quantum state into the Hilbert space of the first quantum state based on the preset quantum state, wherein the preset quantum state may be any quantum state that may be prepared, such as a zero state that may be prepared conveniently.

In generally, the initial quantum state ρ and the target quantum state η obtained by transforming are located in the same Hilbert space S, that is, the corresponding density matrices have the same matrix dimension. Since the first quantum state is obtained by combining K initial quantum states, that is, the first quantum state is a quantum state of a high-dimensional Hilbert space S^{K}, a target quantum state of a Hilbert space S can be embedded into a high-dimensional Hilbert space T = S^{K} based on a preset quantum state such as a zero state, and the embedded quantum state is the second quantum state. The specific embedding method may be achieved by the following transformation ε(W) = W ⊗ |0〉〈0|, that is, through adding the zero state located on the Hilbert space S^{K-1}, any quantum state W on the Hilbert space S may be extended to a quantum state W ⊗ |0〉〈0| on the Hilbert space T. When W is the target quantum state η, ε(W) is the second quantum state.

The auxiliary quantum state may be called as the catalyst quantum state, and the multi-copy target quantum state transformation scheme can be transformed into the single-copy target quantum state transformation scheme with the assistance of the catalyst quantum state. Specifically, based on the quantum state transformation operation under the target transforming relationship of the multi-copy target quantum state transformation scheme, with the assistance of the catalyst quantum state, the first quantum state and the catalyst quantum state can be transformed together, thereby realizing the consumption of K copies of initial quantum states, one copy of target quantum state may be obtained. That is, in this embodiment, with the assistance of the catalyst quantum state, a target quantum state can be obtained by consuming only K initial quantum state stored in the register, which can break the constraint of the theoretical limit on the transformation cost of the single-copy target quantum state.

Correspondingly, based on the first quantum state and the second quantum state, a second quantum system that assists the quantum state can be constructed to assist the transformation of the first quantum state, wherein the constructed second quantum system may include M-1 first quantum sub-systems, and each of the first quantum sub-systems may include M second quantum state components, so that the structure of each of the first quantum sub-systems in the constructed second quantum system is the same as that of the first quantum system, and the first quantum state and the auxiliary quantum state may be merged and transformed together.

Furthermore, the second quantum system includes M-1 first quantum sub-systems, so that after splicing the first quantum system and the second quantum system, M quantum sub-systems can be provided, such that the quantum state transformation operation under the target transforming relationship may be performed for the M quantum state components (i.e. including M*K quantum states) of the M quantum sub-systems in the same dimension. The quantum state transformation operation can realize the multi-copy target quantum state transformation scheme, that is, realize the transformation of N initial quantum states (i.e. M*K initial quantum states) into M target quantum states.

In the specific construction process, the second quantum state component may be set as the first quantum state or the second quantum state, and it is necessary to ensure that at least M-1 second quantum state components are the first quantum states in the second quantum system, so that after splicing the first quantum system and the second quantum system, the quantum state transformation operation under the target transforming relationship may be performed.

In an optional embodiment, in order to perform the quantum state transformation operation under the target transforming relationship without performing any transformation operation, M-1 quantum state components in the same dimension of the M-1 first quantum sub-systems in the second quantum system may be set as the first quantum states, wherein the transformation operation may refer to a dimension in which the transformed quantum state components are located or a quantum system in which the transformed quantum state components are located. For example, the M-1 quantum state components in the M^{th} dimension of the M-1 first quantum sub-systems in the second quantum system may be set as the first quantum state.

In an optional embodiment, the second quantum system may be as shown in FIG. 6, in which each column represents a first quantum sub-system, that is, the second quantum system may include 4 first quantum sub-systems, each row represents a second quantum state component, that is, each first quantum sub-system may include 5 second quantum state components, wherein some second quantum state components 601 may be set as the first quantum state, and the other second quantum state components 602 may be set as a second quantum state. The complete auxiliary quantum state is obtained by performing the uniform probability superposition on the second quantum state components represented by all rows.

Step S103: performing, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

In this step, the quantum state transformation operation can realize the multi-copy target quantum state transformation scheme, that is, realize the transformation of N initial quantum states into M target quantum states.

In an optional embodiment, it is assumed that there is a multi-copy target quantum state transformation scheme F. In a case that N is less than M*K, the M*K-N copies of initial quantum states may be discarded, and then F may be applied to the remaining copies of initial quantum states ρ (which is equivalent to the application to the M first quantum states), that is, the quantum state transformation operation under the target transforming relationship is realized.

In another optional embodiment, it is denoted that the multi-copy target quantum state transformation scheme F may transform M*K initial quantum states, i.e., M first quantum states 701, to obtain the target quantum states, which are denoted as η^{M}, and the quantum states may refer to the quantum states in M Hilbert spaces S.

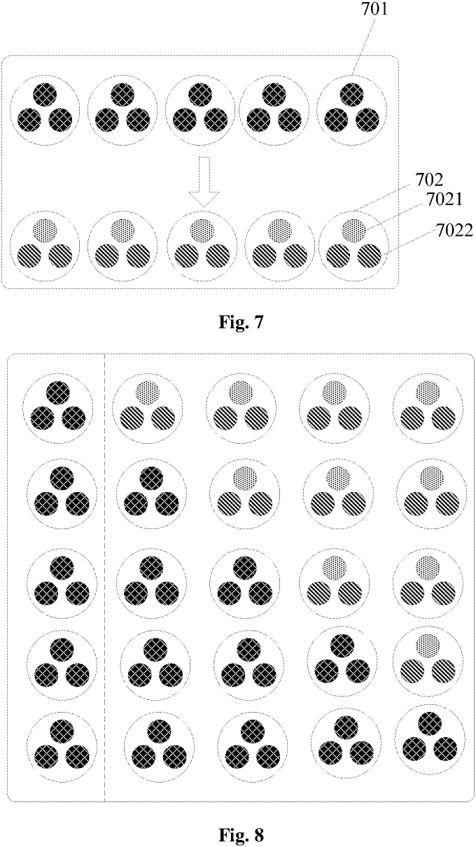

As shown in FIG. 7, each Hilbert space S may be embedded into a high-dimensional Hilbert space T = S^{K}, and the corresponding quantum state being embedded is recorded as η̃^{M}. The specific embedding method may adopt the following transformation ε(W) = W ⊗ |0〉〈0|, that is, through adding the zero state on the Hilbert space S^{K-1}, any quantum state W on the Hilbert space S is extended to the quantum state W ⊗ |0〉〈0| on the Hilbert space T, that is, the embedded quantum state is η̃^{M} = ε^{⊗M}(η^{M}).

The η̃^{M} may include M second quantum states 702, and each second quantum state may include a target quantum state 7021 on the Hilbert space S and two zero states 7022 on the Hilbert space S. In other words, the quantum state transformation operation under the target transforming relationship may refer to transforming M first quantum states into M second quantum states.

The first quantum system and the second quantum system may be spliced to transform the first quantum state and the catalyst quantum state together. The splicing method may be that the first quantum system is spliced before the second quantum system, or the first quantum system is spliced after the second quantum system, which is not specifically limited herein.

Some operations may be performed based on the first target quantum system obtained by splicing, wherein the operations may include quantum state transformation operations under the target transforming relationship, so as to transform the multi-copy target quantum state transformation scheme that may realize the target transforming relationship into the single-copy target quantum state transformation scheme with the assistance of the catalyst quantum state, thereby achieving only consumption of K copies of initial quantum state to obtain one copy of target quantum state.

Transforming the first quantum state and the catalyst quantum state together may refer to transforming the first quantum state into the target quantum state with the assistance of the catalyst quantum state, and while transforming the first quantum state into the target quantum state, the catalyst quantum state may be restored, that is, the catalyst quantum state does not change before and after the transformation.

In this embodiment, the first quantum system in the first quantum state is constructed based on the target transforming relationship; the second quantum system in the auxiliary quantum state is constructed based on the first quantum state and the second quantum state; and based on the quantum state transformation operation under the target transforming relationship, and the first quantum system and the second quantum system, a quantum state transformation is performed on the K initial quantum states and the auxiliary quantum state to obtain the target quantum state and the auxiliary quantum state. In this way, through the use of the catalyst quantum state, any multi-copy target quantum state transformation scheme may be transformed into the single-copy target quantum state transformation scheme with the assistance of the catalyst, and the auxiliary quantum state may be kept unchanged, so that the overall cost of the quantum state transformation may be greatly reduced, and the transformable range of the quantum state may be expanded.

Optionally, the step S102 specifically includes:
constructing, based on M states of a dimension index, second quantum state components that are in dimensions indicated by each of the states and of the M-1 first quantum sub-systems to obtain the second quantum system, wherein the dimension index is used for indicating the dimensions of the second quantum state components;
wherein in a case that the dimension indicated by the state is i, the second quantum state components that are of first i-1 quantum sub-systems of the M-1 first quantum sub-systems and in an i^{th} dimension are set as the first quantum state, and the second quantum state components that are of last M-i quantum sub-systems of the M-1 first quantum sub-systems and in the i^{th} dimension are set as the second quantum state, i is a positive integer less than or equal to M.

In this embodiment, the dimension index may be an index with a dimension of M, which may include M states, represented by |i〉〈i|, 1≤i≤M-1, which is used to indicate the dimension of second quantum state component.

It is denoted that η̃^{1:i} is a quantum state of the quantum state η̃^{M} on the previous i Hilbert spaces T, since η̃^{M} includes M quantum systems, and the Hilbert space of each quantum system is T, and η̃^{1:M} = η̃^{M} may be called as the entire quantum state η̃^{M}, and η̃^{1:0} = 1 is determined as an ordinary quantum state (i.e. a quantum state with a dimension of 1). According to the definition of η̃^{1:i}, the catalyst quantum state may be constructed as shown in the following formula (1).

$$ω = \frac{1}{\text{M}} {\sum }_{i = 1}^{M} {ζ}^{⊗ i - 1} ⊗ {\tilde{η}}^{1 : M - i} ⊗ \left|i\right〉 \left〈i\right| \qquad \text{(1)}$$

The second quantum system in the auxiliary quantum state constructed by the above-mentioned formula (1) may be shown in FIG. 6, the second quantum system in the catalyst quantum state ω, that is, the auxiliary quantum state may include M-1 quantum systems T (i.e. the first quantum sub-system, represented by columns) and a classical system with a dimension of M (i.e., a system in the second quantum state components with a dimension of M), each row represents a quantum state component of the auxiliary quantum state, the complete catalyst quantum state is obtained by performing the uniform probability superposition on the quantum state components represented by all rows, wherein the quantum system T may represent a quantum system whose quantum state is located on the Hilbert space T.

The specific construction method is described as follows: setting, for a given dimension index i (1≤i≤M), first i-1 quantum sub-systems in the M-1 first quantum sub-systems as the first quantum state ζ^{⊗i-1}, that is, setting each of the second quantum state components in the i^{th} dimension of first i-1 quantum sub-systems in the M-1 first quantum sub-systems as the first quantum state, setting the remaining quantum sub-systems as the second quantum state η̃^{1:M-i}, that is, setting each of the second quantum state components in the i^{th} dimension of subsequent M-i quantum sub-systems in the M-1 first quantum sub-systems as the second quantum state, setting the state of the classical system as |i〉〈i|, and performing the uniform probability superposition on the second quantum state components corresponding to all different 1 ≤i≤M, thereby obtaining the auxiliary quantum state ω.

In this embodiment, based on the M states of the dimension index, the second quantum state components in dimensions indicated by respective states of the M-1 first quantum sub-systems are structured to obtain the second quantum system, wherein the dimension index is used for indicating the dimensions of the second quantum state components, so that the construction of catalyst quantum state may be achieved.

Optionally, the second quantum system includes M-1 target quantum state components, the M-1 target quantum state components are located in a same dimension, the M-1 target quantum state components are same, and the target quantum state components are the first quantum state; the step S103 specifically includes:
splicing the first quantum system and the second quantum system to obtain a first target quantum system, wherein in the first target quantum system, the first quantum system is arranged before the second quantum system;
performing the quantum state transformation operation on M third quantum state components to obtain a second target quantum system, wherein the M third quantum state components include the first quantum state component and the M-1 target quantum state components, the quantum state transformation operation includes: transforming the M first quantum states into the M second quantum states;
performing a quantum state exchange operation on the second target quantum system to obtain a third target quantum system, wherein a second quantum sub-system of the third target quantum system includes the M second quantum states, the second quantum sub-system is arranged before M-1 third quantum sub-systems, the third quantum sub-systems are other quantum sub-systems that are other than the second quantum sub-system and in the third target quantum system, the M-1 third quantum sub-systems are same as the M-1 first quantum sub-systems;
performing a restoration operation on the second quantum sub-system to obtain the target quantum state;
performing uniform probability superposition on quantum state components of each of dimensions in the M-1 third quantum sub-systems to obtain the auxiliary quantum state.

In this embodiment, the second quantum system may include M-1 target quantum state components, the M-1 target quantum state components are located in the same dimension, and the M-1 target quantum state components are the same, and the target quantum state components are the first quantum state.

As shown in FIG. 6, each of the M-1 second quantum state components in the M^{th} dimension in the second quantum system is the first quantum state. In the following, FIG. 6 is taken as an example of the catalyst quantum state, and the scheme of performing quantum state transformation on K initial quantum states with the assistance of the catalyst quantum state is described in detail.

The first quantum system and the second quantum system may be spliced to obtain the first target quantum system. During the splicing process, the first quantum system may be arranged before the second quantum system, and represented by ζ ⊗ ω.

The first target quantum system is shown in FIG. 8, the quantum sub-system on the left of the dotted line is the first quantum system, and the quantum sub-system on the right of the dotted line is the second quantum system. The first target quantum system may include M quantum systems T and a classical system with a dimension of M.

Then, a control operation with the classical system as the control bit and the quantum system as the controlled bit may be applied to the first target quantum system to obtain the second target quantum system. Specifically, the control operation may be expressed as id

$$⊗ {\sum }_{i = 1}^{M - 1} \left|i\right〉 \left〈i\right| + F ⊗ \left|M\right〉 \left〈\text{M}\right| ,$$

wherein id represents the identity transformation, that is, not doing any operation, F represents the multi-copy target quantum state transformation scheme. If M*K>N, M*K-N copies of initial quantum states may be discarded, and F is applied to the remaining N copies of initial quantum states ρ. That is, if the control bit is M, the quantum state transformation operation under the target transforming relationship is applied to the controlled bit; otherwise, no operation is performed.

Since the multi-copy target quantum state transformation scheme F has a certain probability of success or failure; in a case that the experiment fails when F is applied, it is necessary to re-prepare the catalyst quantum state, and perform the quantum state transformation again until the experiment succeeds.

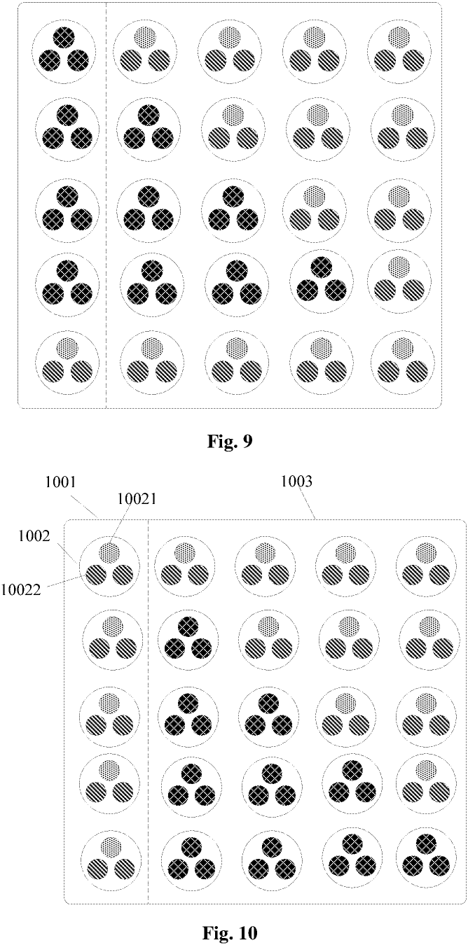

It is denoted that the quantum state after the successful experiment is v₁, and the second target quantum system in the quantum state v₁ is shown in FIG. 9. It can be seen from FIG. 9 that the M quantum state components in the M^{th} dimension in the second target quantum system has been successfully transformed from M first quantum states to M second quantum states, wherein M=5.

Then, a quantum state exchange operation may be performed on the second target quantum system to obtain a third target quantum system, wherein the quantum state exchange operation may include the dimension exchange operation of the quantum state component, and/or, the quantum system exchange operation of the quantum state, the dimension exchange operation of the quantum state component refers to exchanging the dimension of the quantum state component to transform the quantum state component from one dimension into another dimension, the quantum system exchange operation of the quantum state refers to exchanging the quantum system in the quantum state to transform the quantum state from one quantum system into another quantum system.

The third target quantum system may include a second quantum sub-system and a third quantum sub-system, the second quantum sub-system is the quantum system arranged at the forefront, the third quantum sub-system is arranged behind the second quantum sub-system, and the third target quantum system may include M-1 third quantum sub-systems.

The purpose of the quantum state exchange operation is to transform, through the dimension exchange operation of the quantum state component, and/or, the quantum system exchange operation of the quantum state, the M quantum state components included in the quantum system (the quantum system corresponding to K initial quantum states in the arrangement position is the first quantum system) arranged at the forefront into M second quantum states, so as to obtain the second quantum sub-system.

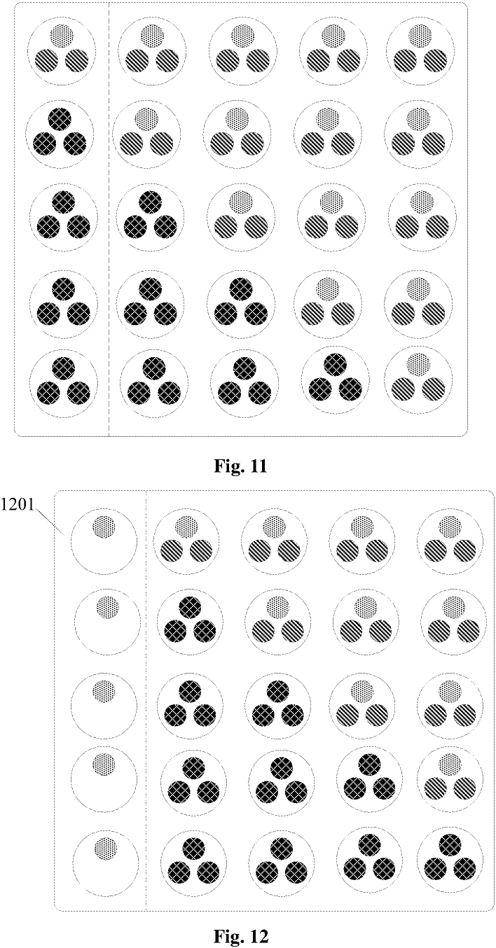

In an optional embodiment, the third target quantum system may be obtained through the quantum state exchange operation. As shown in FIG. 10, the second quantum sub-system 1001 may include 5 second quantum states 1002, the second quantum state 1002 may include a target quantum state 10021 and an embedded preset quantum state 10022.

Since the second quantum state is obtained by embedding the target quantum state into the Hilbert space of the first quantum state based on the preset quantum state. In this way, a restoration operation may be performed on the second quantum sub-system, i.e., M second quantum states, to obtain the quantum system in the target quantum state, and the target quantum state may be obtained based on the quantum system in the target quantum state, wherein the restoration operation may refer to discarding or deleting the preset quantum state at the embedding position in the second quantum state.

Correspondingly, the quantum state transformation operation and quantum state exchange operation are performed on the first target quantum system, the auxiliary quantum state may be restored while obtaining the target quantum state. As shown in FIG. 10, the third target quantum system also includes the quantum system 1003 at the arrangement position of the second quantum system in the auxiliary quantum state, that is, includes M-1 third quantum sub-systems, and the quantum system 1003 at the arrangement position of the second quantum system in the auxiliary quantum state in the third target quantum system is the same as the second quantum system in the auxiliary quantum state as shown in FIG. 6. In this way, the uniform probability superposition is performed on the quantum state components of respective dimensions in the M-1 third quantum sub-systems to obtain the auxiliary quantum state, so that it can be reused subsequently.

In this embodiment, the first quantum system and the second quantum system are spliced to obtain the first target quantum system; the quantum state transformation operation is performed on the M third quantum state components to obtain the second target quantum system; the quantum state exchange operation is performed on the second target quantum system to obtain a third target quantum system, the second quantum sub-system in the third target quantum system includes M second quantum states; a restoration operation is performed on the second quantum sub-system to obtain the target quantum state. In this way, on the basis of splicing the first quantum system and the second quantum system to obtain the first target quantum system, the quantum system corresponding to the K initial quantum states at the arrangement position, i.e., the first quantum system, may be transformed into a quantum system in the target quantum state through performing a series of operations on the first target quantum system (including quantum state transformation operation, the quantum state exchange operation, and the restoration operation under the target transforming relationship). Therefore, with the assistance of the catalyst quantum state, K copies of initial quantum states may be consumed for transformation to obtain one copy of target quantum state, which greatly reduces the overall cost of quantum state transformation.

Optionally, the performing the quantum state exchange operation on the second target quantum system to obtain the third target quantum system includes:
performing, based on the dimensions, a first rotation operation on the quantum state components of each of the dimensions in the second target quantum system, to obtain a fourth target quantum system;
performing, based on the quantum sub-systems, a second rotation operation on each of the quantum sub-systems in the fourth target quantum system, to obtain the third target quantum system.

In this embodiment, the quantum state exchange operation may include the first rotation operation and the second rotation operation, and the first rotation operation may correspond to the dimension exchange operation of the quantum state component, and is used to transform the quantum state component from one dimension into another dimension, and the second rotation operation may correspond to the quantum system exchange operation of the quantum state, and is used to transform the quantum state from one quantum system into another quantum system.

The rotation may refer to transforming the quantum state components in turn, until all the quantum components are transformed, and “based on the dimensions” refers to transforming the quantum state components of one dimension into that of another dimension in batches, and “based on the quantum sub-systems” refers to transforming all the quantum state components in the quantum state from one quantum sub-system into another quantum sub-system in batches.

The first rotation operation may include one, two or even more rotations, and the order of the rotations can be in an ascending order, or a descending order, of the dimensions; the second rotation operation may also include one, two times or even more rotations, the order of the rotations may be in accordance with the order of the quantum sub-systems from front to back, or from back to front, which are not specifically limited herein.

The first rotation operation is performed on the quantum state components of respective dimensions in the second target quantum system with any rotation step size based on the dimension, so as to obtain the fourth target quantum system. In an optional embodiment, the rotation step size may be 1, the first rotation operation may include one rotation, and the order of the rotations may be in an ascending order of the dimensions.

The second rotation operation is performed on respective quantum sub-systems in the fourth target quantum system with any rotation step based on the quantum sub-system, so as to obtain the third target quantum system. In an optional embodiment, the rotation step size may be 1, the second rotation operation may include one rotation, and the order of the rotations may be in accordance with the order of the quantum sub-systems from front to back.

The first rotation operation may be performed by applying a unitary transformation to the classical system in the second target quantum system. Different quantum sub-systems in the fourth target quantum system may be swapped through a swap gate to perform the second rotation operation.

In this embodiment, the M quantum state components included in the quantum system arranged at the forefront may be transformed into the M second quantum states through the first rotation operation and the second rotation operation, so as to obtain the second quantum sub-system, and the implementation of the rotation method is relatively easy.

Optionally, the performing, based on the dimensions, the first rotation operation on the quantum state components of each of the dimensions in the second target quantum system, to obtain the fourth target quantum system includes:

performing, according to an ascending order of the dimensions and a rotation step of 1, a rotation on the quantum state components of each of the dimensions in the second target quantum system, to obtain the fourth target quantum system.

In this embodiment, the order of the rotations may be in an ascending order of the dimensions, with the rotation step size of 1, and through performing only one rotation. The unitary transformation may be implemented using the following formula (2).

$$\text{P} = {\sum }_{i = 1}^{M - 1} \left|i + 1\right〉 \left〈i\right| + \left|1\right〉 \left〈M\right| \qquad \text{(2)}$$

In the formula (2), the quantum state v₁, i.e., the number of the classical system in the second target quantum system, may be rotated, that is, for all 1 ≤ i ≤ M - 1, |i〉〈i| is transformed to |i + 1〉〈i + 1|, and |M〉〈M| is transformed to |1〉〈1|, and the quantum state after rotation is denoted as v₂.

FIG. 9 may be taken as an example, after performing the unitary transformation shown in the formula (2), all the rows in FIG. 9 may be rotated, the last row is moved to the first row, the first row is moved to the second row, and so on, the fourth target quantum system is obtained as shown in FIG. 11.

In this embodiment, the quantum state exchange operation may be further simplified according to an ascending order of dimensions, with the rotation step size of 1, and through performing only one rotation of first rotation operation, thereby simplifying the processing of quantum state transformation.

Optionally, the performing, based on the quantum sub-systems, the second rotation operation on each of the quantum sub-systems in the fourth target quantum system, to obtain the third target quantum system includes:

performing, according to an order of the quantum sub-systems from front to back and a rotation step of 1, a rotation on each of the quantum sub-systems in the fourth target quantum system, to obtain the third target quantum system.

In this embodiment, the quantum state v₂, i.e., the M quantum sub-systems of the fourth target quantum system, may be rotated in a rotation order according to an order of the quantum sub-systems from front to back, with the rotation step size of 1, and through performing only one rotation; the numbers of the quantum sub-systems are denoted as 1, 2,...,M, that is, for all 1 ≤ i ≤ M - 1, the quantum state on the quantum sub-system i is transformed to the quantum sub-system i+1, and the quantum state on the quantum sub-system M is transformed to the quantum sub-system 1. The specific rotation method can be realized by performing the swap gate between adjacent quantum sub-systems, and the quantum state after rotation is denoted as V₃.

FIG. 11 is taken as an example, the rotation of the quantum sub-system is performed on the fourth target quantum system obtained in FIG. 11, that is, all columns in FIG. 11 are rotated, the last column is moved to the first column, and the first column is moved to the second column, and so on, thereby obtaining the third target quantum system as shown in FIG. 10.

In this embodiment, the quantum state exchange operation may be further simplified according to an arrangement order of quantum sub-systems from front to back, with the rotation step size of 1, and through performing only one rotation of second rotation operation, so as to simplify the processing of the quantum state transformation.

Optionally, the performing the restoration operation on the second quantum sub-system to obtain the target quantum state includes:
deleting the preset quantum state embedded in the M second quantum states to obtain a fourth quantum sub-system, wherein the fourth quantum sub-system includes M third quantum states, and the third quantum states are obtained through deleting the preset quantum state;
performing the uniform probability superposition on the M third quantum states to obtain the target quantum state.

In this embodiment, each second quantum state of the second quantum sub-system in the third target quantum system may be processed, specifically, the preset quantum state embedded in each second quantum state may be discarded, that is, the embedded system S^{K-1} in the first quantum system T is discarded, thereby obtaining the fourth quantum sub-system.

As shown in FIG. 12, the embedded systems in the first quantum system T of the quantum state obtained in FIG. 10 are discarded, that is, the dots 10022 in the circles corresponding to the first column in FIG. 10 are discarded, and the fourth quantum sub-system is obtained, the fourth quantum sub-system may include M third quantum states 1201, the M third quantum states are subjected to the uniform probability superposition to output the first quantum system, i.e., the quantum state on the fourth quantum sub-system, the quantum state is the target quantum state, so that the quantum state on the first quantum system may be a single-copy target quantum state. Therefore, the transformation of the single-copy target quantum state with the assistance of the catalyst quantum state may be realized, that is, K copies of initial quantum states are consumed to obtain one copy of target quantum state.

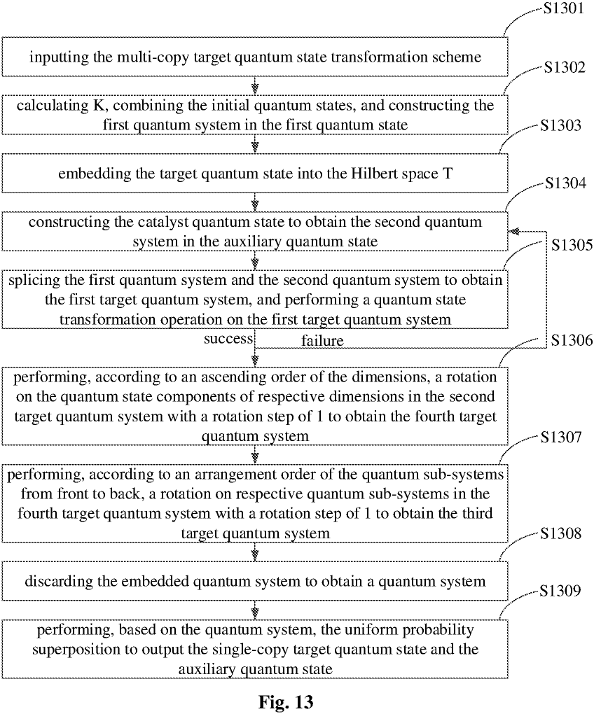

The quantum state transformation scheme provided in this embodiment will be described in detail below with a specific example. As shown in FIG. 13, this example includes the following steps:
Step S1301: inputting the multi-copy target quantum state transformation scheme, whose parameters may include F, N, M, ρ, σ, ∈, p, etc.;
Step S1302: calculating K, combining the initial quantum states, as shown in FIG. 4, and constructing the first quantum system in the first quantum state;
Step S1303: embedding the target quantum state into the Hilbert space T, as shown in FIG. 7;
Step S1304: constructing the catalyst quantum state to obtain the second quantum system in the auxiliary quantum state as shown in FIG. 6;
Step S1305: performing, after splicing the first quantum system in the first quantum state and the second quantum system in the auxiliary quantum state shown in FIG. 5 to obtain the first target quantum system shown in FIG. 8, quantum state transformation operation on the first target quantum system to obtain the second target quantum system as shown in FIG. 9;
Step S1306: performing, according to an ascending order of the dimensions, a rotation on the quantum state components of respective dimensions in the second target quantum system with a rotation step of 1 to obtain the fourth target quantum system shown in FIG. 11;
Step S1307: performing, according to an arrangement order of the quantum sub-systems from front to back, a rotation on respective quantum sub-systems in the fourth target quantum system with a rotation step of 1 to obtain the third target quantum system shown in FIG. 10;
Step S1308: discarding the embedded quantum system to obtain the quantum system shown in FIG. 12;
Step S1309: performing, based on the quantum system shown in FIG. 12, the uniform probability superposition to output the single-copy target quantum state and the auxiliary quantum state.

### Second Embodiment

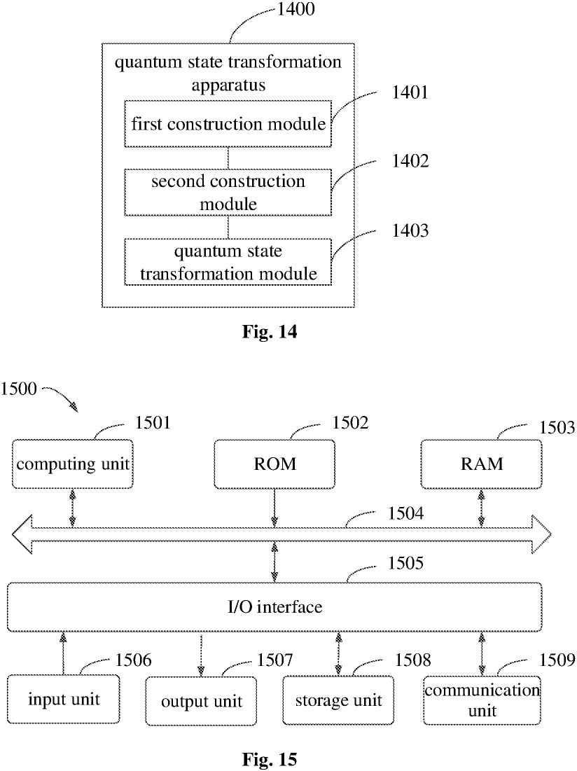

As shown in FIG. 14, the present disclosure provides a quantum state transformation apparatus 1400, which includes:
a first construction module 1401, configured to construct, based on a target transforming relationship, a first quantum system in a first quantum state, wherein the first quantum state includes K initial quantum states, and the target transforming relationship is a transforming relationship between N initial quantum states and M target quantum states, the first quantum system includes M first quantum state components, the first quantum state components are superimposed with a uniform probability to obtain the first quantum state, N and M are both integers greater than 1, N is greater than or equal to M, and K is obtained by rounding up a value of N divided by M;
a second construction module 1402, configured to construct, based on the first quantum state and the second quantum state, a second quantum system in an auxiliary quantum state, wherein the second quantum state is obtained by embedding the target quantum state into Hilbert space of the first quantum state based on a preset quantum state, the second quantum system includes M-1 first quantum sub-systems, the first quantum sub-system includes M second quantum state components, and the second quantum state component is the first quantum state or the second quantum state, the second quantum state components are superimposed with the uniform probability to obtain the auxiliary quantum state;
a quantum state transformation module 1403, configured to perform, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

Optionally, the second construction module 1402 is specifically configured to:
construct, based on M states of a dimension index, second quantum state components that are in dimensions indicated by each of the states and of the M-1 first quantum sub-systems to obtain the second quantum system, wherein the dimension index is used for indicating the dimensions of the second quantum state components;
wherein in a case that the dimension indicated by the state is i, the second quantum state components that are of first i-1 quantum sub-systems of the M-1 first quantum sub-systems and in an i^{th} dimension are set as the first quantum state, and the second quantum state components that are of last M-i quantum sub-systems of the M-1 first quantum sub-systems and in the i^{th} dimension are set as the second quantum state, i is a positive integer less than or equal to M.

Optionally, the second quantum system includes M-1 target quantum state components, the M-1 target quantum state components are located in a same dimension, and the M-1 target quantum state components are the same, and each of the target quantum state components is the first quantum state; the quantum state transformation module 1403 includes:
a splicing submodule, configured to splice the first quantum system and the second quantum system to obtain a first target quantum system, wherein in the first target quantum system, the first quantum system is arranged before the second quantum system;
a first operation submodule, configured to perform the quantum state transformation operation on M third quantum state components to obtain a second target quantum system, wherein the M third quantum state components include the first quantum state component and the M-1 target quantum state components, the quantum state transformation operation includes: transforming the M first quantum states into the M second quantum states;
a second operation submodule, configured to perform a quantum state exchange operation on the second target quantum system to obtain a third target quantum system, wherein a second quantum sub-system of the third target quantum system includes the M second quantum states, the second quantum sub-system is arranged before M-1 third quantum sub-systems, the third quantum sub-systems are other quantum sub-systems that are other than the second quantum sub-system and in the third target quantum system, the M-1 third quantum sub-systems are same as the M-1 first quantum sub-systems;
a third operation submodule, configured to perform a restoration operation on the second quantum sub-system to obtain the target quantum state; and
a superposition submodule, configured to perform uniform probability superposition on quantum state components of each of dimensions in the M-1 third quantum sub-systems to obtain the auxiliary quantum state.

Optionally, the second operation submodule includes:
a first operation unit, configured to perform, based on the dimensions, a first rotation operation on the quantum state components of each of the dimensions in the second target quantum system, to obtain a fourth target quantum system;
a second operation unit, configured to perform, based on the quantum sub-systems, a second rotation operation on each of the quantum sub-systems in the fourth target quantum system, to obtain the third target quantum system.

Optionally, the first operation unit is specifically configured to:

perform, according to an ascending order of the dimensions and a rotation step of 1, a rotation on the quantum state components of each of the dimensions in the second target quantum system, to obtain the fourth target quantum system.

Optionally, the second operation unit is specifically configured to:

perform, according to an order of the quantum sub-systems from front to back and a rotation step of 1, a rotation on each of the quantum sub-systems in the fourth target quantum system, to obtain the third target quantum system.

Optionally, the third operation submodule is specifically configured to:
delete the preset quantum state embedded in the M second quantum states to obtain a fourth quantum sub-system, wherein the fourth quantum sub-system includes M third quantum states, and the third quantum states are obtained through deleting the preset quantum state;
perform the uniform probability superposition on the M third quantum states to obtain the target quantum states.

The quantum state transformation apparatus 1400 provided in the present disclosure can realize each process realized by the quantum state transformation method embodiments, and can achieve the same beneficial effect. Details thereof are not repeated herein to avoid repetition.

In the technical solution of the present disclosure, the collection, storage, usage, processing, transmission, provision, and disclosure, etc., of user’s personal information involved are all in compliance with relevant laws and regulations, and do not violate public order and good customs.

According to an embodiment of the present disclosure, the present disclosure also provides an electronic device, a readable storage medium, and a computer program product.

FIG. 15 shows a schematic block diagram of an exemplary electronic device that may be used to implement embodiments of the present disclosure. Electronic device is intended to represent various forms of digital computers, such as laptops, desktops, workstations, personal digital assistants, servers, blade servers, mainframes, and other suitable computers. Electronic devices may also represent various forms of mobile apparatuses, such as personal digital assistants, cellular telephones, smart phones, wearable devices, and other similar computing apparatuses. The components shown herein, their connections and relationships, and their functions, are by way of example only, and are not intended to limit implementations of the present disclosure described and/or claimed herein.

As shown in FIG. 15, the device 1500 includes a computing unit 1501, which can perform various appropriate actions and processes according to computer programs stored in a read-only memory (ROM) 1502 or loaded from a storage unit 1508 into a random-access memory (RAM) 1503. In the RAM 1503, various programs and data necessary for the operation of the device 1500 can also be stored. The computing unit 1501, ROM 1502, and RAM 1503 are connected to each other through a bus 1504. An input/output (I/O) interface 1505 is also connected to the bus 1504.

Multiple components in the device 1500 are connected to the input/output (I/O) interface 1505, which includes: an input unit 1506, such as a keyboard, a mouse, etc.; an output unit 1507, such as various types of displays, speakers, etc.; a storage unit 1508, such as a magnetic disk, an optical disc, etc.; and a communication unit 1509, such as a network card, a modem, a wireless communication transceiver, and the like. The communication unit 1509 allows the device 1500 to exchange information/data with other devices through a computer network such as the Internet and/or various telecommunication networks.

The computing unit 1501 may be various general-purpose and/or special-purpose processing components having processing and computing capabilities. Some examples of computing units 1501 include, but are not limited to, central processing units (CPUs), graphics processing units (GPUs), various dedicated artificial intelligence (AI) computing chips, various computing units that run machine learning model algorithms, digital signal processor (DSP), and any suitable processor, controller, microcontroller, etc. The computing unit 1501 executes various methods and processes described above, such as the quantum state transformation method. For example, in some embodiments, the quantum state transformation method may be implemented as a computer software program tangibly embodied on a machine-readable medium, such as storage unit 1508. In some embodiments, part or all of the computer program may be loaded and/or installed on the device 1500 via the ROM 1502 and/or the communication unit 1509. When the computer program is loaded into the RAM 1503 and executed by the computing unit 1501, one or more steps of the quantum state transformation method described above may be performed. Alternatively, in other embodiments, the computing unit 1501 may be configured to execute the quantum state transformation method in any other suitable manner (for example, by means of firmware).

Various embodiments of the systems and techniques described above may be implemented in digital electronic circuit systems, integrated circuit systems, field programmable gate arrays (FPGAs), application specific integrated circuits (ASICs), application specific standard products (ASSPs), system-on-chip (SOC), complex programmable logic device (CPLD), computer hardware, firmware, software, and/or combinations thereof. These various embodiments may be implemented in one or more computer programs executable and/or interpreted on a programmable system including at least one programmable processor, the programmable processor may be a special-purpose or general-purpose programmable processor, may receive data and instruction from a storage system, at least one input apparatus, and at least one output apparatus, and transmit data and instruction to the storage system, the at least one input apparatus, and the at least one output apparatus.

Program codes for implementing the methods of the present disclosure may be written in any combination of one or more programming languages. These program codes may be provided to a processor or controller of a general-purpose computer, a special purpose computer, or other programmable data processing apparatuses, so that the program codes, when executed by the processor or controller, enable the functions/operations specified in the flowcharts and/or block diagrams to be implemented. The program codes may be executed entirely on the machine, partly on the machine, and executed partly on the machine and partly on a remote machine or entirely on the remote machine or server as a stand-alone software package.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. More specific examples of machine-readable storage media may include one or more of a wire-based electrical connection, a portable computer disk, a hard disk, a random-access memory (RAM), a read-only memory (ROM), an erasable programmable read only memory (EPROM or flash memory), a fiber optic, a compact disk read-only memory (CD-ROM), an optical storage device, a magnetic storage device, or any suitable combination thereof.

To provide interaction with the user, the systems and techniques described herein may be implemented on a computer having a display (for example, a cathode ray tube (CRT) or liquid crystal display (LCD) monitor) for displaying information to the user; and a keyboard and a pointing apparatus (e.g., a mouse or trackball), the user can provide input to the computer through the keyboard and the pointing apparatus. Other types of apparatuses may also be used to provide interaction with the user; for example, the feedback provided to the user may be any form of sensory feedback (e.g., visual feedback, auditory feedback, or tactile feedback), and may be in any form (including acoustic input, voice input, or tactile input) to receive input from the user.

The systems and techniques described herein may be implemented in a computing system that includes back-end components (e.g., as a data server), or a computing system that includes middleware components (e.g., an application server), or a computing system that includes front-end components (e.g., a user computer having a graphical user interface or web browser through which a user can interact with implementations of the systems and techniques described herein), or including such backend components, intermediary components, or any combination of front-end components in a computing system. The components of the system may be interconnected by any form or medium of digital data communication (e.g., a communication network). Examples of communication networks include: local area networks (LANs), wide area networks (WANs), and the Internet.

A computer system may include a client and a server. The client and the server are generally remote from each other and typically interact through a communication network. The relationship of the client and server may be formed by a computer programs run on the corresponding computer and having a client-server relationship to each other. The server may be a cloud server, a server of a distributed system, or a server with a block chain.

It should be understood that steps may be reordered, added, or removed using the various forms of flow shown above. For example, each step described in the present disclosure may be executed in parallel, sequentially, or in a different order, as long as the desired result of the technical solution disclosed in the present disclosure can be achieved, which is not further particularly defined herein.

The specific embodiments described above do not limit the protection scope of the present disclosure. It should be apparent to those skilled in the art that various modifications, combinations, sub-combinations and substitutions may be made depending on design requirements and other factors. Any modifications, equivalent replacements and improvements made within the spirit and principles of the present disclosure shall be included within the protection scope of the present disclosure.

What is claimed is:

1. A quantum state transformation method, comprising:
constructing, based on a target transforming relationship, a first quantum system in a first quantum state, wherein the first quantum state comprises K initial quantum states, and the target transforming relationship is a transforming relationship between N initial quantum states and M target quantum states, the first quantum system comprises M first quantum state components, the first quantum state components are superimposed with a uniform probability to obtain the first quantum state, N and M are both integers greater than 1, N is greater than or equal to M, and K is obtained by rounding up a value of N divided by M;
constructing, based on the first quantum state and a second quantum state, a second quantum system in an auxiliary quantum state, wherein the second quantum state is obtained by embedding a target quantum state into Hilbert space of the first quantum state based on a preset quantum state, the second quantum system comprises M-1 first quantum sub-systems, at least one of the first quantum sub-systems comprises M second quantum state components, and at least one of the second quantum state components is the first quantum state or the second quantum state, and the second quantum state components are superimposed with the uniform probability to obtain the auxiliary quantum state;
performing, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

2. The quantum state transformation method according to claim 1, wherein constructing, based on the first quantum state and the second quantum state, the second quantum system in the auxiliary quantum state comprises:
constructing, based on M states of a dimension index, second quantum state components that are in dimensions indicated by each of the M states and of the M-1 first quantum sub-systems to obtain the second quantum system, wherein the dimension index is used for indicating the dimensions of the second quantum state components;
wherein in a case that a dimension indicated by a state is i, the second quantum state components that are of first i-1 quantum sub-systems of the M-1 first quantum sub-systems and in an i^{th} dimension are set as the first quantum state, and the second quantum state components that are of last M-i quantum sub-systems of the M-1 first quantum sub-systems and in the i^{th} dimension are set as the second quantum state, i is a positive integer less than or equal to M.

3. The quantum state transformation method according to claim 1, wherein:
the second quantum system comprises M-1 target quantum state components;
the M-1 target quantum state components are located in a same dimension;
the M-1 target quantum state components are same;
the M-1 target quantum state components are the first quantum state;
performing, based on the quantum state transformation operation under the target transforming relationship, and the first quantum system and the second quantum system, the quantum state transformation on the K initial quantum states and the auxiliary quantum state, to obtain the target quantum state and the auxiliary quantum state further comprises:
splicing the first quantum system and the second quantum system to obtain a first target quantum system, wherein in the first target quantum system, the first quantum system is arranged before the second quantum system;
performing the quantum state transformation operation on M third quantum state components to obtain a second target quantum system, wherein the M third quantum state components comprise the first quantum state component and the M-1 target quantum state components, and the quantum state transformation operation comprises transforming M first quantum states into M second quantum states;
performing a quantum state exchange operation on the second target quantum system to obtain a third target quantum system, wherein a second quantum sub-system of the third target quantum system comprises the M second quantum states, the second quantum sub-system is arranged before M-1 third quantum sub-systems, the third quantum sub-systems are other quantum sub-systems that are other than the second quantum sub-system and in the third target quantum system, and the M-1 third quantum sub-systems are same as the M-1 first quantum sub-systems;
performing a restoration operation on the second quantum sub-system to obtain the target quantum state;
performing uniform probability superposition on quantum state components of each of dimensions in the M-1 third quantum sub-systems to obtain the auxiliary quantum state.

4. The quantum state transformation method according to claim 3, wherein performing the quantum state exchange operation on the second target quantum system to obtain the third target quantum system comprises:
performing, based on the dimensions, a first rotation operation on the quantum state components of each of the dimensions in the second target quantum system, to obtain a fourth target quantum system;
performing, based on quantum sub-systems, a second rotation operation on each quantum sub-system in the fourth target quantum system, to obtain the third target quantum system.

5. The quantum state transformation method according to claim 4, wherein performing, based on the dimensions, the first rotation operation on the quantum state components of each of the dimensions in the second target quantum system, to obtain the fourth target quantum system comprises:
performing, according to an ascending order of the dimensions and a rotation step of 1, a rotation on quantum state components of each dimension in the second target quantum system, to obtain the fourth target quantum system.

6. The quantum state transformation method according to claim 4, wherein performing, based on the quantum sub-systems, the second rotation operation on each of the quantum sub-systems in the fourth target quantum system, to obtain the third target quantum system comprises:
performing, according to an order of the quantum sub-systems from front to back and a rotation step of 1, a rotation on each of the quantum sub-systems in the fourth target quantum system, to obtain the third target quantum system.

7. The quantum state transformation method according to claim 3, wherein performing the restoration operation on the second quantum sub-system to obtain the target quantum state comprises:
deleting a preset quantum state embedded in the M second quantum states to obtain a fourth quantum sub-system, wherein the fourth quantum sub-system comprises M third quantum states, and the M third quantum states are obtained through deleting the preset quantum state embedded in the M second quantum states;
performing the uniform probability superposition on the M third quantum states to obtain the target quantum state.

8. An electronic device, comprising:
at least one processor;
a memory communicatively connected to the at least one processor; wherein
the memory is configured to store at least one instruction executable by the at least one processor, and the at least one processor is configured to execute the at least one instruction to implement a quantum state transformation method comprising:
constructing, based on a target transforming relationship, a first quantum system in a first quantum state, wherein the first quantum state comprises K initial quantum states, and the target transforming relationship is a transforming relationship between N initial quantum states and M target quantum states, the first quantum system comprises M first quantum state components, the first quantum state components are superimposed with a uniform probability to obtain the first quantum state, N and M are both integers greater than 1, N is greater than or equal to M, and K is obtained by rounding up a value of N divided by M;
constructing, based on the first quantum state and a second quantum state, a second quantum system in an auxiliary quantum state, wherein the second quantum state is obtained by embedding a target quantum state into Hilbert space of the first quantum state based on a preset quantum state, the second quantum system comprises M-1 first quantum sub-systems, at least one of the first quantum sub-systems comprises M second quantum state components, and at least one of the second quantum state components is the first quantum state or the second quantum state, the second quantum state components are superimposed with the uniform probability to obtain the auxiliary quantum state;
performing, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

9. The electronic device according to claim 8, wherein constructing, based on the first quantum state and the second quantum state, the second quantum system in the auxiliary quantum state comprises:
constructing, based on M states of a dimension index, second quantum state components that are in dimensions indicated by each of the M states and of the M-1 first quantum sub-systems to obtain the second quantum system, wherein the dimension index is used for indicating the dimensions of the second quantum state components;
wherein in a case that a dimension indicated by a state is i, the second quantum state components that are of first i-1 quantum sub-systems of the M-1 first quantum sub-systems and in an i^{th} dimension are set as the first quantum state, and the second quantum state components that are of last M-i quantum sub-systems of the M-1 first quantum sub-systems and in the i^{th} dimension are set as the second quantum state, and wherein i is a positive integer less than or equal to M.

10. The electronic device according to claim 8, wherein the second quantum system comprises M-1 target quantum state components, the M-1 target quantum state components are located in a same dimension, the M-1 target quantum state components are same, and the target quantum state components are the first quantum state;
performing, based on the quantum state transformation operation under the target transforming relationship, and the first quantum system and the second quantum system, the quantum state transformation on the K initial quantum states and the auxiliary quantum state, to obtain the target quantum state and the auxiliary quantum state comprises:
splicing the first quantum system and the second quantum system to obtain a first target quantum system, wherein in the first target quantum system, the first quantum system is arranged before the second quantum system;
performing the quantum state transformation operation on M third quantum state components to obtain a second target quantum system, wherein the M third quantum state components comprise the first quantum state component and the M-1 target quantum state components, the quantum state transformation operation comprises: transforming M first quantum states into M second quantum states;
performing a quantum state exchange operation on the second target quantum system to obtain a third target quantum system, wherein a second quantum sub-system of the third target quantum system comprises the M second quantum states, the second quantum sub-system is arranged before M-1 third quantum sub-systems, the third quantum sub-systems are other quantum sub-systems that are other than the second quantum sub-system and in the third target quantum system, and the M-1 third quantum sub-systems are same as the M-1 first quantum sub-systems;
performing a restoration operation on the second quantum sub-system to obtain the target quantum state;
performing uniform probability superposition on quantum state components of each of dimensions in the M-1 third quantum sub-systems to obtain the auxiliary quantum state.

11. The electronic device according to claim 10, wherein performing the quantum state exchange operation on the second target quantum system to obtain the third target quantum system comprises:
performing, based on the dimensions, a first rotation operation on the quantum state components of each of the dimensions in the second target quantum system, to obtain a fourth target quantum system;
performing, based on the quantum sub-systems, a second rotation operation on each quantum sub-system in the fourth target quantum system, to obtain the third target quantum system.

12. The electronic device according to claim 11, wherein performing, based on the dimensions, the first rotation operation on the quantum state components of each of the dimensions in the second target quantum system, to obtain the fourth target quantum system comprises:
performing, according to an ascending order of the dimensions and a rotation step of 1, a rotation on quantum state components of each dimension in the second target quantum system, to obtain the fourth target quantum system.

13. The electronic device according to claim 11, wherein performing, based on the quantum sub-systems, the second rotation operation on each of the quantum sub-systems in the fourth target quantum system, to obtain the third target quantum system comprises:
performing, according to an order of the quantum sub-systems from front to back and a rotation step of 1, a rotation on each of the quantum sub-systems in the fourth target quantum system, to obtain the third target quantum system.

14. The electronic device according to claim 10, wherein performing the restoration operation on the second quantum sub-system to obtain the target quantum state comprises:
deleting a preset quantum state embedded in the M second quantum states to obtain a fourth quantum sub-system, wherein the fourth quantum sub-system comprises M third quantum states, and the M third quantum states are obtained through deleting the preset quantum state embedded in the M second quantum states;
performing the uniform probability superposition on the M third quantum states to obtain the target quantum state.

15. A non-transitory computer-readable storage medium storing a computer instruction, wherein the computer instruction is used to be executed by a computer to implement a quantum state transformation method comprising:
constructing, based on a target transforming relationship, a first quantum system in a first quantum state, wherein the first quantum state comprises K initial quantum states, and the target transforming relationship is a transforming relationship between N initial quantum states and M target quantum states, the first quantum system comprises M first quantum state components, the first quantum state components are superimposed with a uniform probability to obtain the first quantum state, N and M are both integers greater than 1, N is greater than or equal to M, and K is obtained by rounding up a value of N divided by M;
constructing, based on the first quantum state and a second quantum state, a second quantum system in an auxiliary quantum state, wherein the second quantum state is obtained by embedding a target quantum state into Hilbert space of the first quantum state based on a preset quantum state, the second quantum system comprises M-1 first quantum sub-systems, at least one of the first quantum sub-systems comprises M second quantum state components, and at least one of the second quantum state components is the first quantum state or the second quantum state, the second quantum state components are superimposed with the uniform probability to obtain the auxiliary quantum state;
performing, based on a quantum state transformation operation under the target transforming relationship, and the first quantum system and the second quantum system, a quantum state transformation on the K initial quantum states and the auxiliary quantum state, to obtain the target quantum state and the auxiliary quantum state.

16. The non-transitory computer-readable storage medium according to claim 15, wherein constructing, based on the first quantum state and the second quantum state, the second quantum system in the auxiliary quantum state comprises:
constructing, based on M states of a dimension index, second quantum state components that are in dimensions indicated by each of the M states and of the M-1 first quantum sub-systems to obtain the second quantum system, wherein the dimension index is used for indicating the dimensions of the second quantum state components;
wherein in a case that a dimension indicated by a state is i, the second quantum state components that are of first i-1 quantum sub-systems of the M-1 first quantum sub-systems and in an i^{th} dimension are set as the first quantum state, and the second quantum state components that are of last M-i quantum sub-systems of the M-1 first quantum sub-systems and in the i^{th} dimension are set as the second quantum state, and wherein i is a positive integer less than or equal to M.

17. The non-transitory computer-readable storage medium according to claim 15, wherein the second quantum system comprises M-1 target quantum state components, the M-1 target quantum state components are located in a same dimension, the M-1 target quantum state components are same, and the target quantum state components are the first quantum state;
the performing, based on the quantum state transformation operation under the target transforming relationship, and the first quantum system and the second quantum system, the quantum state transformation on the K initial quantum states and the auxiliary quantum state, to obtain the target quantum state and the auxiliary quantum state comprises:
splicing the first quantum system and the second quantum system to obtain a first target quantum system, wherein in the first target quantum system, the first quantum system is arranged before the second quantum system;
performing the quantum state transformation operation on M third quantum state components to obtain a second target quantum system, wherein the M third quantum state components comprise the first quantum state component and the M-1 target quantum state components, the quantum state transformation operation comprises: transforming M first quantum states into M second quantum states;
performing a quantum state exchange operation on the second target quantum system to obtain a third target quantum system, wherein a second quantum sub-system of the third target quantum system comprises the M second quantum states, the second quantum sub-system is arranged before M-1 third quantum sub-systems, the third quantum sub-systems are other quantum sub-systems that are other than the second quantum sub-system and in the third target quantum system, and the M-1 third quantum sub-systems are same as the M-1 first quantum sub-systems;
performing a restoration operation on the second quantum sub-system to obtain the target quantum state;
performing uniform probability superposition on quantum state components of each of dimensions in the M-1 third quantum sub-systems to obtain the auxiliary quantum state.

18. The non-transitory computer-readable storage medium according to claim 17, wherein performing the quantum state exchange operation on the second target quantum system to obtain the third target quantum system comprises:
performing, based on the dimensions, a first rotation operation on the quantum state components of each of the dimensions in the second target quantum system, to obtain a fourth target quantum system;
performing, based on the quantum sub-systems, a second rotation operation on each quantum sub-system in the fourth target quantum system, to obtain the third target quantum system.

19. The non-transitory computer-readable storage medium according to claim 18, wherein performing, based on the dimensions, the first rotation operation on the quantum state components of each of the dimensions in the second target quantum system, to obtain the fourth target quantum system comprises:
performing, according to an ascending order of the dimensions and a rotation step of 1, a rotation on quantum state components of each dimension in the second target quantum system, to obtain the fourth target quantum system.

20. The non-transitory computer-readable storage medium according to claim 18, wherein performing, based on the quantum sub-systems, the second rotation operation on each of the quantum sub-systems in the fourth target quantum system, to obtain the third target quantum system comprises:
performing, according to an order of the quantum sub-systems from front to back and a rotation step of 1, a rotation on each of the quantum sub-systems in the fourth target quantum system, to obtain the third target quantum system.
